(19) United States
(12) Patent Application Publication
(10) Pub. No.: US 2019/0147608 A1
(43) Pub. Date: May 16, 2019

(54) MULTIPURPOSE DIGITAL RAPID PROFILE PROJECTOR AND METHODS OF USE

(71) Applicant: Arun Kumar, Bangalore (IN)

(72) Inventor: Arun Kumar, Bangalore (IN)

(21) Appl. No.: 16/248,100

(22) Filed: Jan. 15, 2019

Related U.S. Application Data
(63) Continuation of application No. PCT/IB2017/054393, filed on Jul. 20, 2017.

(30) Foreign Application Priority Data
Jul. 20, 2016 (IN) 201641002176

(51) Int. Cl. G06T 7/521; G01B 11/25; G01B 11/02; H04N 5/225; G06T 7/00

(52) U.S. Cl. CPC G06T 7/521; G01B 11/25; G01B 11/024; G06T 2207/10024; H04N 5/2253; G06T 7/0004; G06T 2207/30164; H04N 5/2254

(57) ABSTRACT

The present invention provides a multipurpose digital rapid profile projector (100), wherein the projector (100) comprises a sheet metal housing supporting a work stage (106), The work stage (106) may be fixed or moves in X, Y and Z axis. A telecentric lens (102) is a fixed or zoom magnification lens with large field of view accurately fitted and aligned in the housing. A high resolution digital camera (103) is mounted on the lens (102). The output signals from the camera (103) are fed to a computer system (104) containing vision metrology application software. The computer system (104) containing display (101) may be a touch screen or a normal monitor (101). A profile lamp house (105) projects collimated beam of light into the telecentric lens (102) axis. A surface lamp house (107) projects light onto the component reflecting into the telecentric lens (102).

### CROSS-REFERENCE TO RELATED APPLICATIONS

The present application claims priority from and is a continuation from PCT application serial no. PCT/IB2017/054393, filed Jul. 20, 2017; which claims priority from Indian Patent application serial no. IN 201641002176, filed Jul. 20, 2016, herein incorporated by reference in their entireties.

### BACKGROUND

The present invention relates generally to an optical metrology measuring instrument. More particularly, the invention relates to a non-contact optical inspection for quality and dimension control of the manufactured parts.

A profile projector is an optical instrument which is used to measure the dimension and inspect the quality of parts of a machine during their manufacturing. The projector enlarges the shape of the parts and displays it on the display screen. The parts of the machine are measured by placing the parts to be inspected on the workstage. A very accurate magnified image of the part is displayed on the screen. The magnified image of the part is measured by the machine. Since the magnified part is measured (instead of the actual small part), very accurate measurements of upto one thousandth of a millimeter cam be done.

Today, large numbers of optical instruments are used for measuring and inspecting the dimension and accuracy of the manufactured parts such as profile projectors, video measuring machines, field of view inspection system, etc.

Various types of conventional profile projectors are known in the prior art, wherein most of the profile projectors have poor quality of the image when subjected to surface illumination. The measurement process involved in these types of projectors is very slow and the color image obtained is of very low quality. The accuracy of results totally depends on the operator's skill and consistency.

Further, in the existing systems, such as video measuring machines, the field of view is very small wherein only a small portion of the part or component can be projected during inspection. These machines may not be able to measure or inspect the dimension and quality of heavy, bulky and large parts.

Hence, looking at the problems in the prior art, there is a need of a multipurpose digital rapid profile projector which provides a large field of view and a high quality color image. The device should also allow to measure and inspect the dimension and quality of large and heavy parts quickly.

### SUMMARY OF THE INVENTION

The present invention overcomes the drawbacks in the prior art and provides a multipurpose digital rapid profile projector for measuring the dimensions and inspecting the quality of parts of a machine. The multipurpose digital rapid profile projector comprises of a work stage which is supported by a sheet metal housing and is used for focusing the part in front of the lens. The workstage moves in X, Y and Z axis, or may also be a fixed stage for placing the part. A telecentric lens used in the present invention is a fixed magnification or zoom magnification lens with a larger field of view which is accurately fitted and aligned in the housing. A high resolution digital camera is mounted on the lens and the output signals from the camera are fed to a computer system containing vision metrology application software. A display is being used in the present invention which may be a touch screen or a normal monitor. The projector enlarges the shape and displays the shape of the parts on the display screen. The parts of the machine are measured by placing the parts to be inspected on the workstage. A very accurate magnified image of the part is displayed on the screen. The magnified image of the part is measured by the machine. The magnified view of a particular part of the machine displayed on the screen calculates the linear measurements, radii, angles, curves, etc.

It is to be understood that both the foregoing general description and the following details description are exemplary and explanatory and are intended to provide further explanation of the invention as claimed.

The methods, systems, and apparatuses are set forth in part in the description which follows, and in part will be obvious from the description, or can be learned by practice of the methods, apparatuses, and systems. The advantages of the methods, apparatuses, and systems will be realized and attained by means of the elements and combinations particularly pointed out in the appended claims. It is to be understood that both the foregoing general description and the following detailed description are exemplary and explanatory only and are not restrictive of the methods, apparatuses, and systems, as claimed.

### BRIEF DESCRIPTION OF THE DRAWINGS

In the accompanying figures, like elements are identified by like reference numerals among the several preferred embodiments of the present invention.

FIG. 1 illustrates the perspective view of a multipurpose digital rapid profile projector, in accordance to one or more embodiments of the invention.

FIG. 2 illustrates the orthogonal front view of the multipurpose digital profile projector, in accordance with an embodiment of the invention.

### DETAILED DESCRIPTION OF THE INVENTION

The foregoing and other features and advantages of the invention are apparent from the following detailed description of exemplary embodiments, read in conjunction with the accompanying drawings. The detailed description and drawings are merely illustrative of the invention rather than limiting, the scope of the invention being defined by the appended claims and equivalents thereof.

Embodiments of the invention will now be described with reference to the Figures, wherein like numerals reflect like elements throughout. The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes or which is essential to practicing the invention described herein.

The use of the terms “a” and “an” and “the” and similar referents in the context of describing the invention are to be construed to cover both the singular and the plural, unless otherwise indicated herein or clearly contradicted by context. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Recitation of ranges of values herein are merely intended to serve as a shorthand method of referring individually to each separate value falling within the range, unless otherwise indicated herein, and each separate value is incorporated into the specification as if it were individually recited herein. The word “about,” when accompanying a numerical value, is to be construed as indicating a deviation of up to and inclusive of 10% from the stated numerical value. The use of any and all examples, or exemplary language (“e.g.” or “such as”) provided herein, is intended merely to better illuminate the invention and does not pose a limitation on the scope of the invention unless otherwise claimed. No language in the specification should be construed as indicating any nonclaimed element as essential to the practice of the invention.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, electrical, and medical arts. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Reference will now be made in detail to the description of the present subject matter, one or more examples of which are shown in figures. Each example is provided to explain the subject matter and not a limitation. Various changes and modifications obvious to one skilled in the art to which the invention pertains are deemed to be within the spirit, scope and contemplation of the invention.

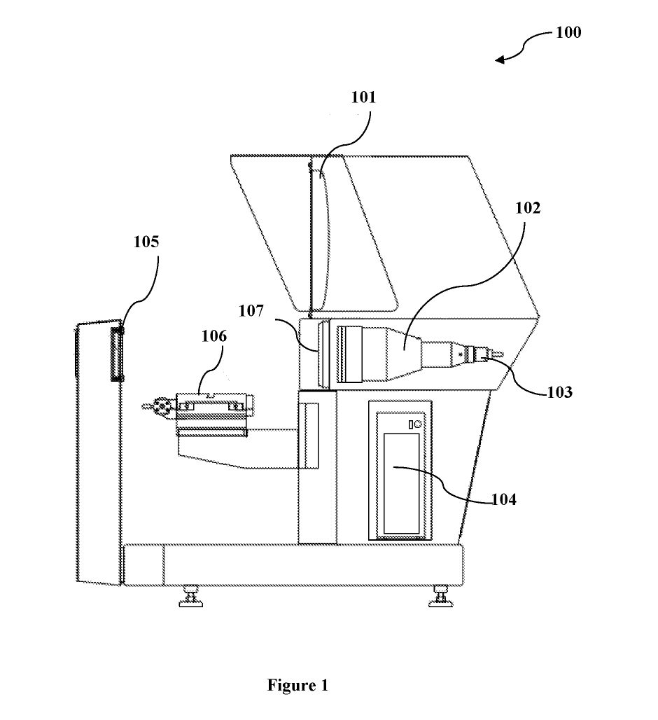

The present invention overcomes the drawbacks of the technology models available in the state of the art by providing a multipurpose digital rapid profile projector, wherein the digital rapid profile projector comprises a sheet metal housing which supports a work stage, wherein the work stage moves in X, Y, Z axis or may be fixed. A telecentric lens is accurately fitted and aligned in the housing, wherein telecentric lens is a fixed magnification lens or zoom magnification lens with large field of view. A high resolution digital camera is mounted on the lens. The output signals from the camera are fed to the computer system containing vision metrology application software, wherein the computer system may be a touch screen or a normal monitor. The software will recognize the part. By adding a CNC (Computer Numeric Controller Unit), the workstage can be automated to move in a pre-programmed mode; thereby automating the scanning of parts larger than the field of view. In addition to a horizontal lens axis as shown in FIG. 1 the multipurpose digital rapid profile projector is also available with a vertical lens axis.

The present invention provides an excellent quality of color image with a large field of view. The size of the parts bigger than the field of view of the lens can also be inspected by mounting them on the workstage and moving the work stage to scan the entire part. The present invention can be adapted to inspect the heavy, bulky and large parts as well. The measurement process involved in the present invention is very fast and independent of operator's skill.

FIG. 1 illustrates the perspective view of a multipurpose digital rapid profile projector, in accordance to one or more embodiments of the invention. The present invention provides a multipurpose digital rapid profile projector, wherein the digital rapid profile projector comprises a sheet metal housing which supports a work stage, wherein the work stage (106) moves in X, Y, Z axis. A telecentric lens (102) is accurately fitted and aligned in the housing, wherein the telecentric lens (102) is a fixed magnification or zoom magnification lens with large field of view. A high resolution digital camera (103) is mounted on the lens. The output signals from the camera (103) are fed to a computer system (104) containing vision metrology application software, wherein the display (101) of the computer system may be a touch screen or a normal monitor.

The image of the part is captured by the lens and camera. The captured image is fed to the computer system, which displays the image on a monitor and carries out the data processing to produce drawings, tolerance of the parts, generation of Pass/Fail Reports and Statistical Process Control (SPC) reports. These reports help in monitoring and controlling the process and ensure that the process operates at its full potential.

In the preferred embodiment of the present invention, the device covers a large field of view of the part, which provides the complete view of the part for measuring accurate dimensions and inspecting the quality of the part.

In the preferred embodiment of the present invention, the digital rapid profile projector (100) comprises the monitor fixed directly in front of the operators face and the workstage controls are directly in line with the user's hands. Hence the present invention is a very ergonomic design and ensures the ease of use and comfort to the user, accomplishing high productivity.

In the preferred embodiment of the present invention, the color image provides excellent clarity even in low lighting conditions and high magnifications.

In the preferred embodiment of the present invention, the work stage (106) moves in X, Y, Z direction, which allows the inspection of long or large parts that are bigger than the field of view of lens.

In the preferred embodiment of the present invention, the digital rapid profile projector (100) provides rapid inspection of the parts by capturing and processing the entire field of view in one shot, in a few seconds.

In the preferred embodiment of the present invention, the digital rapid profile projector (100) provides sound activated signals to alert the operator on the completion of process.

The present invention is a multi-purpose machine which may achieve various operations such as those of a profile projector, video measuring machine, a field of view inspection system, a shaft inspection system, a gear inspection system, etc.

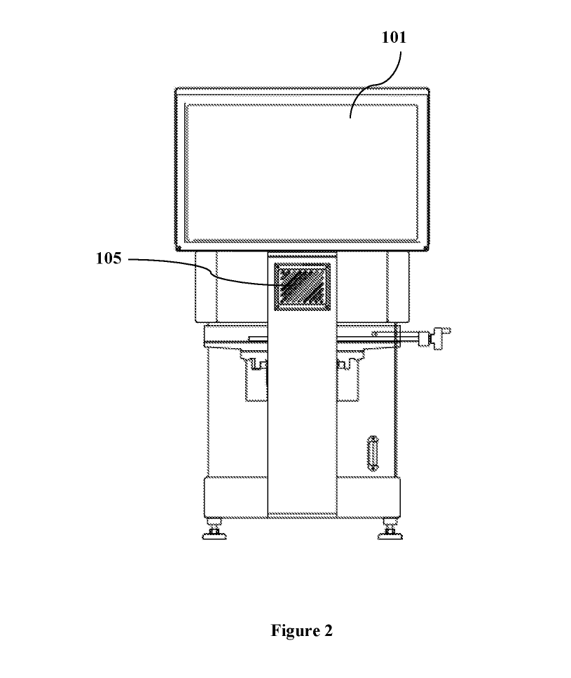

FIG. 2 illustrates the orthogonal front view of the multipurpose digital rapid profile projector, in accordance with an embodiment of the invention. The present invention provides an excellent quality of color image and enables large field of view. Parts bigger than the field of view of the lens can also be inspected by mounting the parts on the X, Y, Z workstage and moving the work stage to measure the entire part. The present invention can be used to inspect the heavy, bulky and large parts as well. The measurement process involved in the present invention is very fast and independent of operator's skill.

While the present invention has been particularly shown and described with reference to exemplary embodiments thereof, it will be understood by those of ordinary skill in the art that various changes in form and details may be made therein without departing from the spirit and scope of the present invention as defined by the following claims.

As used in this application, the term “computer system” is intended to refer to a computer-related entity, either hardware, a combination of hardware and software, software, or software in execution. For example, a computer system can be, but is not limited to being, a process running on a processor, a processor, an object, an executable, a thread of execution, a program, and/or a computer. By way of illustration, both an application running on a server and the server can be a computer system. One or more computer systems can reside within a process and/or thread of execution, and a component can be localized on one computer and/or distributed between two or more computers.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Software includes applications and algorithms. Software may be implemented in a smart phone, tablet, or personal computer, in the cloud, on a wearable device, or other computing or processing device. Software may include logs, journals, tables, games, recordings, communications, SMS messages, Web sites, charts, interactive tools, social networks, VOIP (Voice Over Internet Protocol), e-mails, and videos.

In some embodiments, some or all of the functions or process(es) described herein and performed by a computer program that is formed from computer readable program code and that is embodied in a computer readable medium. The phrase “computer readable program code” includes any type of computer code, including source code, object code, executable code, firmware, software, etc. The phrase “computer readable medium” includes any type of medium capable of being accessed by a computer, such as read only memory (ROM), random access memory (RAM), a hard disk drive, a compact disc (CD), a digital video disc (DVD), or any other type of memory.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

What is claimed is:

1. A multipurpose digital rapid profile projector (100) for measuring the dimensions and inspecting the quality of parts of a machine, the projector comprising:
a) a work stage (106) supported by a sheet metal housing;
b) a telecentric lens (102) accurately fitted and aligned in the sheet metal housing;
c) a high resolution digital camera (103) mounted on the telecentric lens (102);
d) a computer system (104) containing vision metrology application software;
e) display (101) of the computer system;
f) A profile lamp house (105) projecting collimated beam of light into the telecentric lens (102) axis; and
g) A surface lamp house (107) projecting light onto the component which reflects into the telecentric lens (102).

2. A multipurpose digital rapid profile projector (100) as claimed in claim 1, wherein the said work stage (106) may be fixed, or moves in X, Y and Z axis and this movement allows the inspection of long or large parts that are bigger than the telecentric lens (102).

3. A multipurpose digital rapid profile projector (100) as claimed in claim 1, wherein the said telecentric lens (102) is a fixed magnification or zoom magnification lens with a larger field of view.

4. A multipurpose digital rapid profile projector (100) as claimed in claim 1 wherein the said digital camera (103) and telecentric lens (102) captures and processes image of the entire part in one shot.

5. A multipurpose digital rapid profile projector (100) as claimed in claim 1, wherein the image captured from the said camera (103) is fed to the said computer system (104).

6. A multipurpose digital rapid profile projector (100) as claimed in claim 4, wherein the image captured from the said camera (103) is fed to the said computer system (104).

7. A multipurpose digital rapid profile projector (100) as claimed in claim 1, wherein the said display (101) may be a touch screen or a normal monitor.

8. A multipurpose digital rapid profile projector (100) as claimed in claim 1, wherein the said computer system (104) displays the image on a monitor and carries out the data processing to produce drawings, tolerance of the parts, generating pass or fail reports and statistical process control reports.

9. A multipurpose digital rapid profile projector (100) as claimed in claim 1, wherein the controls of said workstage (106) are directly in line with the users hands ensuring ease of use and comfort to the user, accomplishing high productivity.

10. A multipurpose digital rapid profile projector (100) as claimed in claim 1, wherein the said projector (100) provides sound activated signals alarming the operator on the completion of process.
